(19) United States
(12) Patent Application Publication
(10) Pub. No.: US 2013/0153615 A1
(43) Pub. Date: Jun. 20, 2013

(54) GOLF CART CLUB RACK

(71) Applicant: Brian Bond Gibson, Geelong (AU)

(72) Inventor: Brian Bond Gibson, Geelong (AU)

(21) Appl. No.: 13/818,619

(22) PCT Filed: Apr. 27, 2011
(86) PCT No.: PCT/AU2011/000473

§ 371 Date: Feb. 22, 2013

(30) Foreign Application Priority Data
Aug. 23, 2010 (AU) 2010903770

(51) Int. Cl. B60R 7/08

(52) U.S. Cl. CPC B60R 7/08
USPC 224/274

(57) ABSTRACT

The disclosed golf cart club rack comprises two parallel shelves forming a frame that can be attached to the carry bag frame of a motorised golf cart to accommodate two player's golf clubs and accessories. The two shelves have notched cavities to hold the maximum number of clubs a golfer may legally carry during a round of golf. The cavities hold the clubs securely in position whilst offering easy access and visibility for removal and replacement during a round of golf. The golf cart club rack is moulded to hold and secure both right hand and left hand golf clubs. The golf cart club rack has provision to carry golf accessories required during a round, including individual locations for tees, balls, club brush, ball retriever and umbrella, as well as provision for a separate accessory box. The rack can also be fitted with a club lock for added security.

Whilst playing golf using a motorised golf cart, golfers carry their golf clubs (hereafter referred to as clubs) inside a golf bag strapped to the golf cart's carry bag frame. The bag itself is placed in the golf cart's bag well, positioned at the rear of the golf cart. This set-up has at least three disadvantages: clubs in the bag require club head covers to protect the club heads from damaging each other; in order to remove and replace the clubs (and their covers) the golfer must withdraw and replace each club to the full length of the golf bag, expending considerable effort and time; and the clubs are carried in the golf bag do not have distinctive positioning within the bag and can lead to confusion in identifying and selecting the correct club the player has chosen for the next shot.

This invention is specially devised to allow golfers to carry their clubs within the bag well of a two person motorised golf cart without using a golf bag. This allows the golfer clear vision of, and easy access to, their clubs while affording secure storage of the clubs whilst the golf cart moves around the course.

The clubs are suspended in an upside down position, i.e. the club head up and the shaft handle down. Use of club head covers is not necessary when using the club rack, as the club heads are held in spaced troughs to prevent contact between each other on the rack. A separate bracket forward of the top shelf is reserved for putter clubs allowing easy access, simple placement and removal; again increasing convenience and saving playing time.

The club rack also enables storage of golfing accessories (such as ball cleaner brush, tees, balls, ball retriever and umbrella), in a uniform layout affording easy access, and with additional provision for attachment of an accessory storage bag each side.

The golf cart club rack is comprised of two shelves made from stable composite material one spaced above the other and held in a level position by metal arms that are attached to the bag frame. The shelves have oval-shaped openings, which in turn have notched cavities wherein a variety of club holding sleeves are fit to hold the clubs. The sleeves have different core hole sizes, depending on the type of club to be fitted. On the bottom shelf, these cavities fit flexible entry sleeves in the entry channels with flexible entry wings that bend to permit shaft entry and withdrawal afford secure holding of the clubs.

The top shelf sits directly above the bottom shelf and holds the wood type clubs using the same method as described above. Iron club heads are secured in position through use of an entry channel wide enough to allow the shaft below the hoozle to enter the cavity into an enlarged hole sufficient to capture the iron club directly at the knee position of the club head and the hoozle. The club once placed into the enlarged hole will drop (by gravity) and be suspended in a locked position.

The top of the shelf is also grooved and/or raised to form channels that match the top line angle of the iron for each club thereby preventing lateral and turning movement during the course of a round. The irons are suspended and held clear of the of the golf carts' bag well floor whereas the ends of the grip handle of the woods are set vertically resting on the golf cart bag floor. Putter clubs are held upon a bracket attached to the top shelf that extends forward of the leading edge of the shelf.

Hybrid clubs are installed into the hybrid sleeve similar way to the iron club with the club shaft passing through the hybrid shaft opening and then released to sit into the cup head of the hybrid sleeve, where the hoozle restricts the release of the club from the hybrid sleeve.

The invention is designed having a club weather shield to protect the handles of the clubs from rain, which would otherwise cause the player to lose control of the club.

The invention also has a club lock whereby the clubs are locked securely in the rack preventing removal and theft of the clubs whilst the golf cart is unsupervised.

The invention attaches securely to the golf cart's bag frame by attaching and locking frame lock plates to the metal support arms over the golf cart bag strapping frame. The plates are secured with connection bolts top and bottom and the three secured positions of the frame arms ensure the stability of the golf cart club rack. The invention is easily attached by loosely bolting first the top bolts of each metal support arm and frame lock plate, and then attaching the three bottom bolts.

To remove the golf cart frame one reverses the operation by the removal of the three lower locking bolts and lifting the frame from the carry bag frame.

The invention is designed to hold both left hand and right hand golf clubs. The top shelf moulded with furrows and mounds wherein the top line of the iron clubs are held and prevented from lateral movement thus preventing club head damage. The capacity of the shelves and the putter bracket is for the maximum amount of clubs permitted under the rules of golf (14 clubs for each player). The clubs carried on the shelves and held in their selected, respective club sleeve, allows for the clubs to be carried in any combination, and arranged in any order or position within the shelves.

The invention may be better understood with reference to the illustrations of embodiments of the inventions as follows:

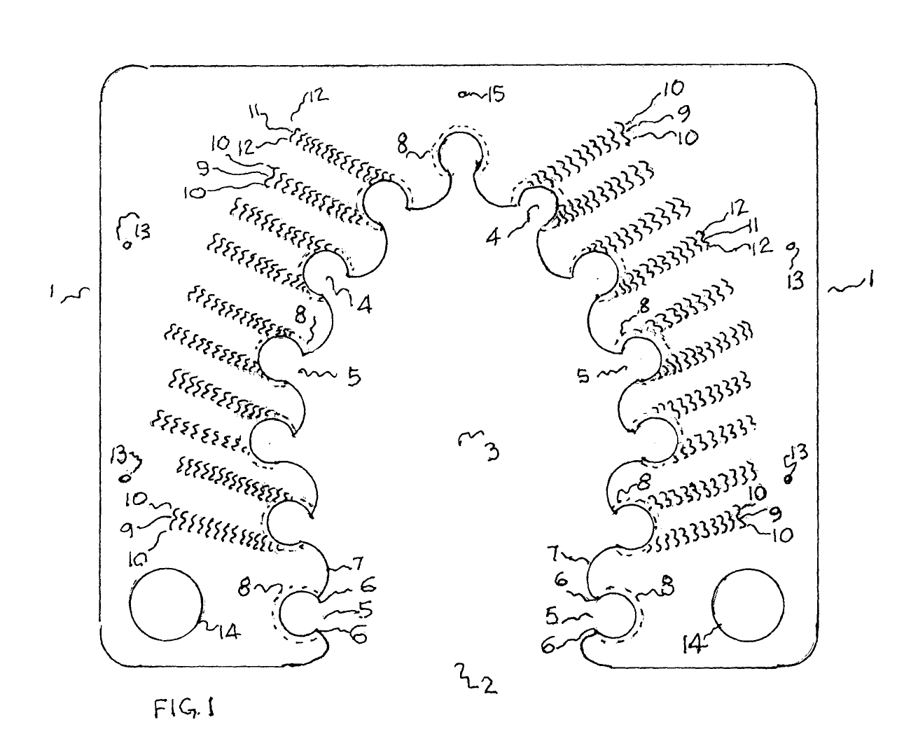

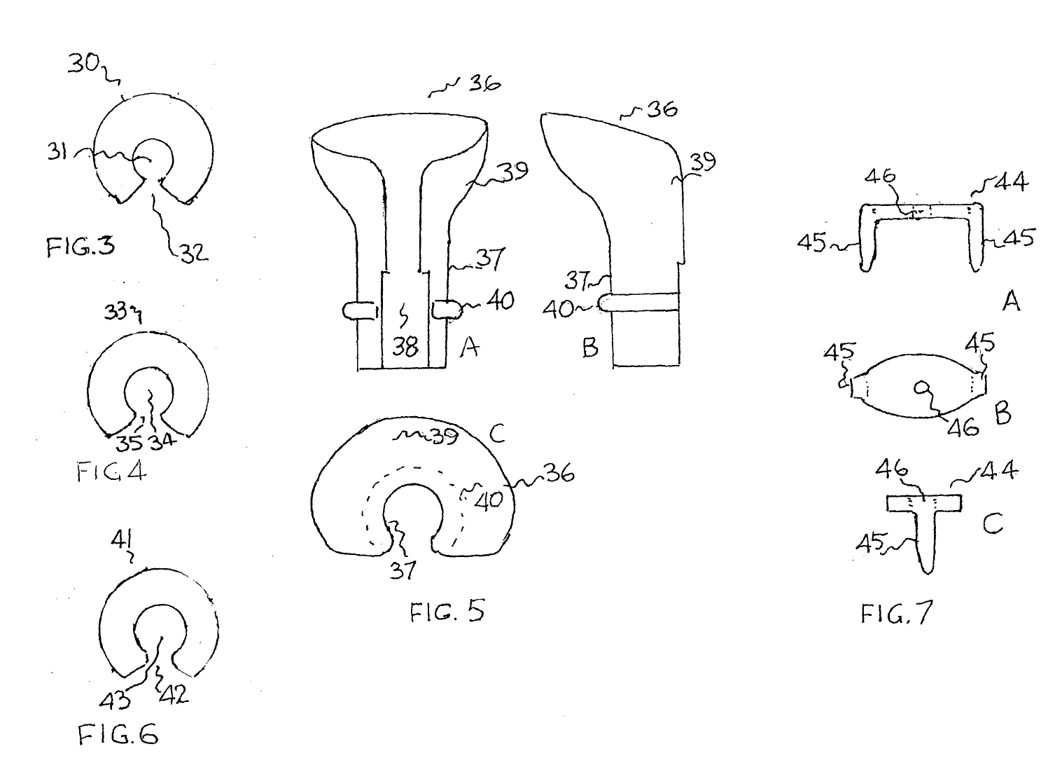

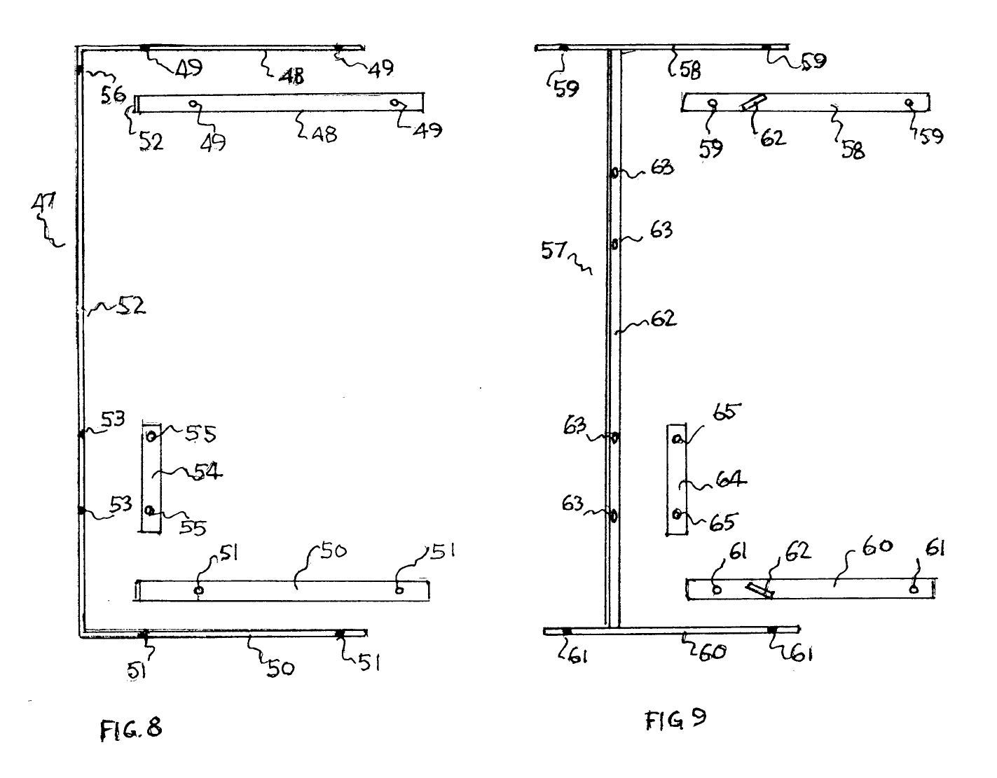

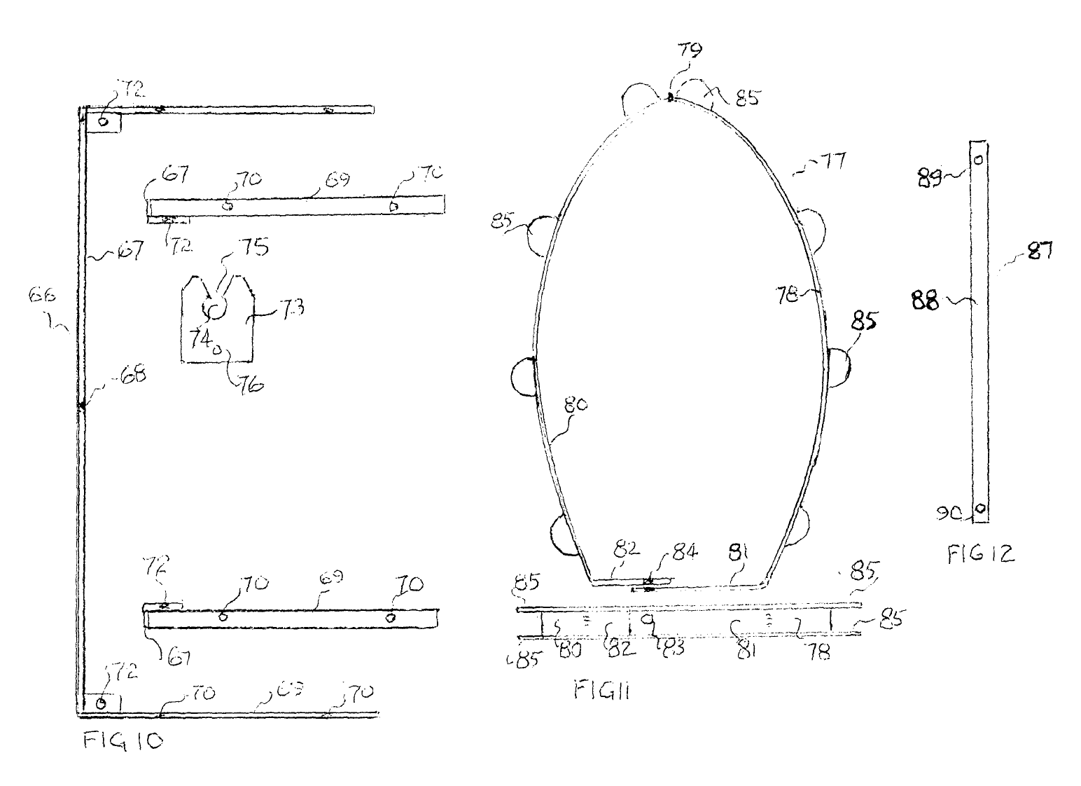

FIG. 1 is a plan of the top shelf 1. The top shelf 1 represents one-half of the two-piece complete top shelves as shown in FIG. 14. The top shelf 1 is moulded from a stable composite, durable weatherproof material and is formed as shown with the club entry opening 2 affording access for the clubs to enter the oval shape harbour 3. The perimeter of the oval shape harbour 3 has thirteen club station cavities 4 with station entry 5 allowing entry for the club into the club station cavity 4. Linked from the station head 6 of each of the station entry 5 a peninsula 7 projects into the harbour 3 for securing the clubs held in the club lock bracket 77 as in FIG. 11. The station cavity 4 is formed with the station groove 8 for holding the wood club sleeve 30 as in FIG. 3, the iron club sleeve 33 as in FIG. 4 and the hybrid club sleeve 36 as in FIG. 5. The wood club sleeve 30, the iron club sleeve 33 and the hybrid club sleeve 36 are moulded from flexible resilient material. The wood club sleeve 30 is for holding wood clubs; the iron club sleeve 33 is for holding iron clubs and the hybrid club sleeve 36 is for holding hybrid clubs. The top shelf 1 is formed with furrow 9 where the top line of the right hand club rests with the mound 10 positioned either side of the club. The furrow 11 is where the top line of the left hand iron club head rests with the mound 12 positioned either side of the club. Each club head is held seated and protected from damage. A simple wall or bollard division between the heads of the clubs can also be used to prevent lateral movement. Each of the club sleeves are fixed into their respective selected position on the top shelf 1 into the station groove 8 with their shaft entry aligned to the station entry 5. To secure the wood club to the top shelf 1 the shaft of the wood club is passed through the wood club sleeve 30, shaft entry 32 then into the shaft rest 31 with the bottom of the club handle resting on the cart bag well floor. The shaft entry 31 is formed with a smaller opening than the club shaft she where as the shaft rest is the size of the shaft, the resilient flexible material forming the wood club sleeve 30 permits entry of the shaft into the shaft rest 32 through to the shaft entry 31 where it is then held. To remove the wood club held in the wood club sleeve 30 the club is passed back from the shaft rest 31 back through the shaft entry 32 and then released. The iron club sleeve 33 as in FIG. 4 is formed with a hoozle rest 34 the size of the wood club's hoozle and a shaft entry 35 is the size of the iron club shaft. The iron sleeve 33 fit inside the station groove 8 to be held in the station cavity 4 on the top shelf 1, with the shaft entry 35 aligned to the station entry 5. The iron club is secured in the top shelf 1 by passing the iron club shaft, directly below the hoozle, through the iron sleeve 33 shaft entry 35 where the club is then released and falls by gravity with the hoozle of the iron club in the hoozle rest 34 and suspended with the “top line” of the club head in the furrow 10 or 11, depending on the hand of the club, and between the mounds 12 or 13, depending on the hand of the club, with each side of the furrows assisting to prevent lateral movement of the club head. To release the iron club from the iron club sleeve 33 the procedure is reversed. The hybrid club sleeve 36 as in FIG. 5 is the plan and elevation of the hybrid club sleeve 36 for holding the hybrid club. The hybrid sleeve 36 is connected to the top shelf 1 with the hybrid club sleeve 36 hybrid flange 40 is placed inside of the station groove 8 formed in the club station cavity 4 and the hybrid shaft entry 38 aligned to the station groove 8. The hybrid club is secured similar to the iron club by passing the shaft directly below the hoozle through the hybrid shaft entry 38 into the hybrid stem 37. The club once released falls by gravity allowing the hybrid club head to rest suspended secure in the hybrid cup 39. The hybrid club sleeve 36 may be moulded with an extended stem 37 to hold a wood club on the top shelf 1 in the same way as the hybrid club securing the head of the wood club into the hybrid cup 39 holding the wood club suspended off the floor of the cart bag well. The two top shelves 1 are joined laterally end to end forming the complete top shelf as shown in FIG. 14 by inserting the joining plate 44 joining legs 45 as in FIG. 7, into the connection hole 13 on the top shelf 1. The two top shelf 1 as shown in FIG. 15 is secured to the golf cart club rack centre support bracket 47 as in FIG. 8 by passing a bolt through the joining plate 44, shelf connection 46 and then extending the bolt through the connection hole 13 of the top shelf 1. The connection hole 13 when assembled on the outer end edge of the two top shelves 1 are for securing the outer end edges of the two top shelve 1 to the end shelf support bracket 57, as in FIG. 9 by connecting the top shelf 1, connection hole 13 to the top arm 58, top arm connection 59. The connection hole 13 when located on the outer edges of the top shelves 1 can also be used for connecting the accessory bag 96, as in FIG. 14. The utility hole 14 is for holding golf accessory items such as: a long handle putter; an extension arm ball retriever; or an umbrella, when aligned with the corresponding utility hole or the umbrella point holder in the bottom shelf 16. The putter support bracket 65 as in FIG. 10 is connected on the underside of the top shelf 1 putter bracket connection 15 and the putter bracket 66 top shelf connection 72.

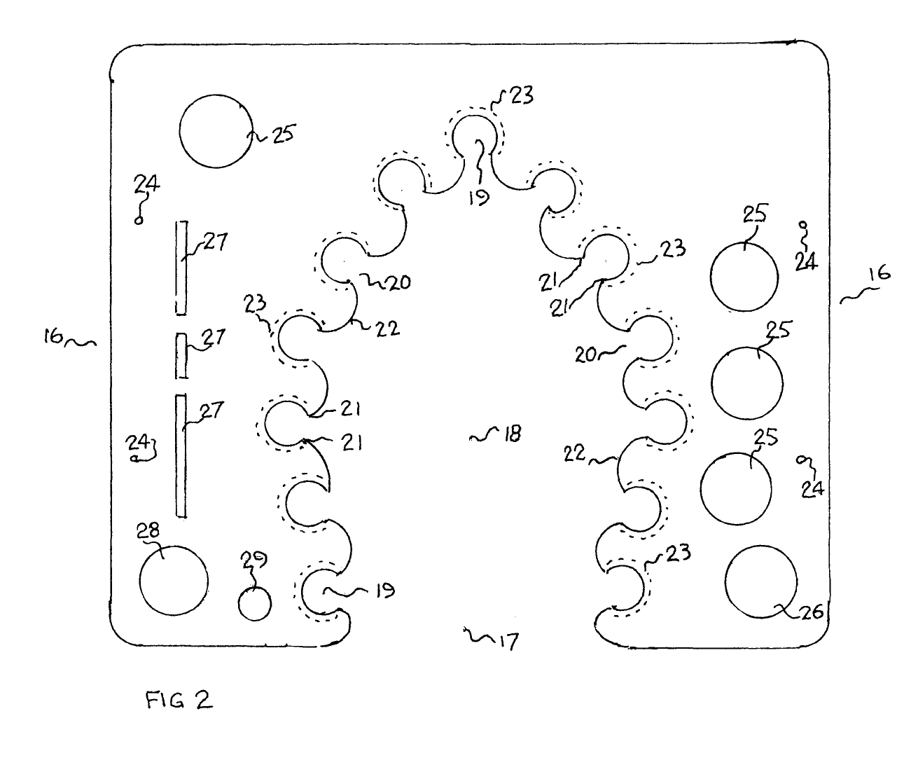

FIG. 2 is a plan of the bottom shelf 16. The bottom shelf 16 represents one-half of the two piece complete top shelve (as shown in FIG. 15). The bottom shelf 16 is moulded from a stable composite durable weather proof material, and from the rear edge of bottom shelf 16 there is a club entry 17 where the clubs pass through into an oval shape harbour 18. The perimeter of the oval shape harbour 18 has thirteen club station cavity 19 formed with a station entry 20 and with the recess groove 23 to hold the wood club sleeve 41. Linked from the station heads 21 of the club entry access openings 19, a peninsula 21 is projected into the oval shape harbour 17 to hold the club lock bracket 77 (as in FIG. 11). The two bottom shelf 16 are joined laterally end to end forming the complete bottom shelf as shown (as shown in FIG. 15) by inserting the joining plate 44, joining legs 45 (as shown in FIG. 7) into the bottom shelf connection 24. The bottom shelf 16, is supported and secured to the centre shelf support bracket 47 bottom arm 53 by a bolt passed through the bottom shelf 16 connection hole 24 then extended through the bottom shelf connection 5. The connection hole 24 when located on the outer edge of the bottom shelve 16 are for connecting the bottom shelf 16 to the end support bracket 57 top arm 58 through bottom shelf connection 68. The club station cavity 19 hold the bottom shelf sleeve 41 as in FIG. 6 fit into the station groove 23 of the club station cavity 26. The wood, iron and hybrid clubs are held in the bottom shelf sleeve 41 shaft rest 43 by the shaft, of these club types. The club station cavities 19 are aligned to the station cavities 5 on the top shelf 1. The bottom shelf sleeve 41 is moulded from flexible resilient material to fit inside the station groove 23 with the bottom shelf sleeve 41 shaft entry 42 aligned to the bottom shelf 16 station entry 20. The bottom shelf sleeve 41 shaft rest 43 is formed having the same diameter as the shaft of the club to held in the shaft rest 43 whereas the shaft entry 42 has an opening diameter smaller than the shaft diameter that will flex open as the club shaft passes through and then be held in the shaft rest 42 to hold the selected club in the bottom sleeve. The spare ball 25 is for carrying spare golf balls on the bottom shelf 16. The umbrella point holder 29 is to hold an umbrella when it is aligned to the corresponding utility hole 14 on the top shelf 1. The utility hole 26 holds golf club accessories such as: a long handle putter; an extension arm ball retriever; when passed through the corresponding utility hole in the top shelf 1. The ball brush is held in the ball brush holder 28. Golf tees are carried in the tee trench 27.

FIG. 3 is a plan of the wood 30, for holding right or left hand wood type clubs on top shelf 1. The wood sleeve 30 is fitted to the top shelf 1 into the station groove 8 inside the club station cavity 4 aligned with the station entry 5 and moulded from a flexible resilient material, formed with the shaft hole 31 the diameter size the same diameter size as the shaft of the club to be held. The shaft entry 32 is a smaller entry size than the diameter of the shaft of the club to be held. The shaft of the selected club is passed into the in the wood sleeve 30 where in the shaft entry 32 will flex open and close as the shaft is settled in the shaft hole 31 to remove the club the shaft entry 32 will flex open and release the shaft of the club.

FIG. 4 is a plan of the iron club sleeve 33 for holding iron clubs on top shelf 1. The iron club sleeve is fitted to the top shelf 1 in the station groove 8 inside the club station cavity 4 and is moulded from a flexible resilient material and is formed with the hoozle rest 34 the size of the hoozle of the iron club and has a shaft entry 35 the shaft size for the shaft to pass through. The iron club shaft is passed through the shaft entry 35 at the shaft directly below the hoozle into the hoozle rest 34 and released to fall by gravity whereby locating the hoozle, of the iron club, level with the hoozle rest 34, and the smaller shaft entry 35 preventing release of the club from the hoozle hole 34. Once in this position the top line of the iron club head sits into the furrow 10 or 11 between the mounds 12 and 13 depending upon the hand of the club, preventing the iron club heads from moving and clashing thus preventing club head damage.

FIG. 5 is a plan and elevation of the hybrid club sleeve 36 for holding right or left hand hybrid clubs on the top shelf 1. The hybrid club sleeve 36 is held in the top shelf 1 by the hybrid flange 40 fitted into the station groove 8 in station cavity 4 with the hybrid shaft entry 38 aligned to the station entry 5. The hybrid club sleeve 36 is moulded from a resilient flexible material formed with a hybrid shaft entry 38 that permits the hybrid shaft directly below the hybrid hoozle to enter the hybrid stem 37 therein the club is released and fall by gravity into the hybrid club sleeve 36 with hybrid club head held in the hybrid cup 39 and the hoozle of the club restrained by the hybrid shaft entry 38.

FIG. 6 is a plan of the bottom shelf sleeve 41. The bottom shelf sleeve 41 fits into the station groove 23 with the shaft entry 23 aligned to the station entry 20 for holding the shaft of all the club types, i.e. wood, iron and hybrid. The bottom shelf sleeve 41 is moulded from a flexible resilient material and formed with a shaft entry 42 smaller than the club shaft and a shaft rest 43 the size of the shaft for holding all club shafts. To secure the shaft of the club into the shaft rest 42 the shaft is passed through the club entry 43 whereby the shift entry 43 will flex open and return closed having passed into the shaft rest 42. To remove the club from the shaft rest 42 the club is passed through the shaft entry 43 that will flex open releasing the club from the bottom shelf sleeve 41.

FIG. 7 is a plan and elevation of a metal joining plate 44 for joining the two top shelves 1 and the two bottom shelves 16 laterally end to end. The joining plate 44 also secures the two joined top shelves 1 and two joined bottom shelves 16 to the centre shelf support 47 and the end support bracket 57 respectively. The two top shelves 1 are joined laterally end to end by inserting each joining leg 45 into each top shelf connection 13. The two bottom shelves 16 are joined laterally end to end by inserting each joining leg 45 into each bottom shelf connection 24. To connect the two top shelves 1 to the centre shelf support 47, top arm 48 the top arm connection 49 is connected to the joining plate 44 shelf connection 46. To connect the two bottom shelf 16 to the centre shelf support 47 bottom arm 51 the bottom arm connection is connected to the joining plate 44 shelf connection 46.

FIG. 8 is a plan and elevation of a metal centre shelf support bracket 47 to secure the two top shelves 1 at the centre and the outer ends of the complete top shelf, as shown in FIG. 15 and all as described in the above paragraph, FIG. 7. The centre support bracket 47 centre support 52 is attached to the golf cart with the golf bag strapping frame connected, between the frame lock 54, and the centre support 52 by bolts through connection 53 and lock connection 55 respectively as shown in FIG. 15. The centre support bracket 47 putter arm connection 56 is for connecting the putter support bracket 66.

FIG. 9 is a plan and elevation of a metal end support bracket 57 to hold and support each outer end of the two top shelf 1 and each outer end of the two bottom shelf 26, thereby forming the golf cart club frame as shown in FIG. 15 and as described in the above paragraph, FIG. 7. The end support bracket 57 is attached to the golf cart with the golf bag strapping bag frame connected between the frame lock 64 and the centre support 62 by the bottom arm 61 connected to the lock connection 65.

FIG. 10 is a plan and elevation of a metal putter support bracket 66 to hold and carry the two putters required for golfers to play. The support putter bracket 66 is attached to the centre shelf support 47 with the putter arm connection 56 connected to the bracket connection 68. The putter support bracket 66 is connected to the two top shelves 1 with the putter bracket connection 15 connected to the top shelf connection 72. The putter support bracket 66 is formed with a putter arm 69 extending 90 degrees from each end of the centre support 67 to carry each putter wall 73. The putter wall 73 is moulded with a putter rest 74 wherein the putter shaft is held. The putter wall 73 is formed with a club entry 75 for the putter shaft to pass, to be held in the putter rest hole 74. Each putter arm 69 has two putter wall connections 70 for connecting to the putter wall connection 76. The putter brace connection 71 connects to the single bag brace 87 putter brace connection 90.

FIG. 11 is a plan and section details of a metal club lock bracket 77, the width of the shelf 1 and 16, for locking the shaft of the clubs held in top shelf 1 and/or the bottom shelf 16. The golf club shaft is held inside the club station cavities 4 of the top shelf 1 and club station 19 of the bottom shelf 16, and is then locked in their holding positions by the club lock bracket 77 preventing the removal of the club from the golf cart club rack. The hold arm 78 and hold arm 80 are formed curved to match the tips of the peninsulas 7 and 22 in the harbours 3 and 18 respectively with a half circle cap 85 extending from the top and bottom edge of the hold arms 78 and 80. The hold arms 78 and 80 are joined on one end with a hinge 79 permitting the hinged unit to open and close. The lock arm 81 extends from the hold arm 78 and has a padlock hole 83 opposite the padlock hole 84 formed in the lock arm 82 extending from the hold arm 80. A padlock is passed through the padlock holes and closed to lock all of the clubs held in the top shelf 1 and bottom 2 when in a closed locked position. To remove the clubs the padlock is unlocked and the holding arms 78 and 80 are moved toward each other and the club lock bracket is withdrawn for the clubs to be released from the top shelf 1 and the bottom shelf 2.

FIG. 12 is a metal bag holding brace 86 used when a single golf bag is held in one side of the golf cart bag well. One shelf 1 and one shelf 16 is removed from the golf cart club rack. The brace arm 87, putter connection 88 is connected to the putter support 66 brace connection 71 and to the centre shelf support 47 centre support connection 53 is connected to the centre connection 89 the putter support bracket 66 is now supported on the side the golf bag will be placed with the putter support bracket in use for both players.

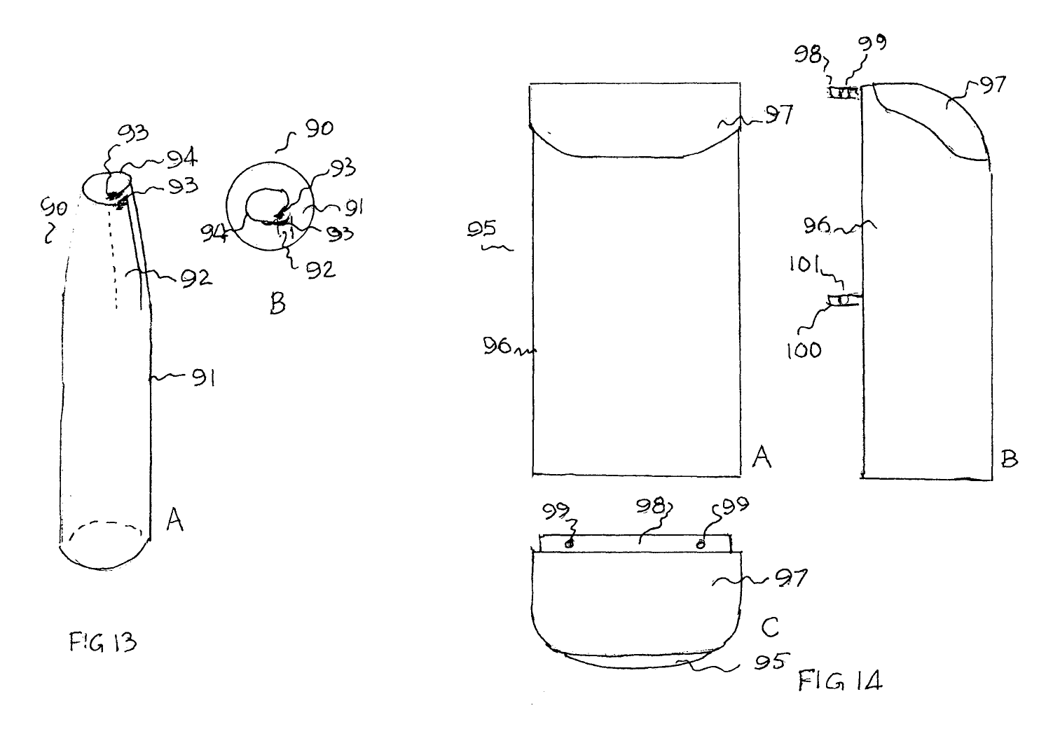

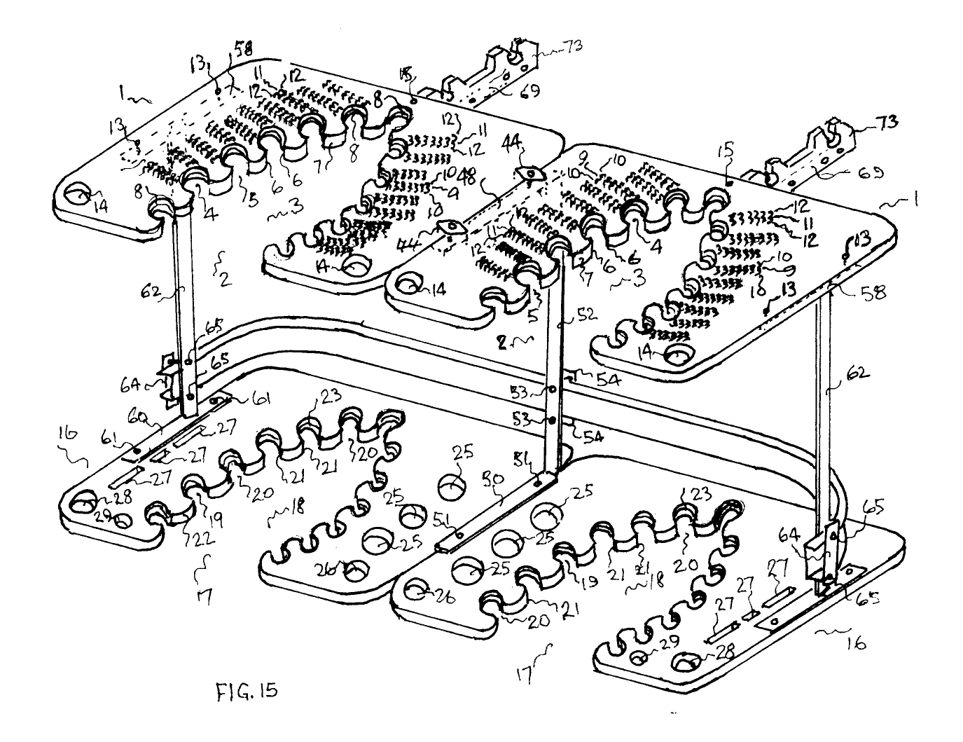

FIG. 13 is a plan and elevation of a club weather shield 90. The weather shield 90 protects the club handle from rain. The weather shield 90 is made from a water proof material with a handle cover 91 having a shaft collar 94, a folded flap 92 and on each corner there is a clasp 93 made from loop fabric material and with a hook fabric material to engage with each other to close and release from the shaft directly above the handle of the club. The folded flap 92 is wrapped tightly around the shaft with the clasp 93 the clasp secured to prevent water covering the club handle and the clasp is released and the weather shield removed when the club is to be used.

FIG. 14 is a plan and elevations of the accessory bag 95. The accessory bag 95 is made from waterproof material with the bag body 96 access through a flap opening 97. The accessory bag 95 is attached to the top shelf 1 top shelf connection 13, and the top bag connection 99 formed in the bag lapped edge 98. The accessory bag 96 is attached to bottom shelf 16 bottom shelf connection 24 and the bottom bag connection 101 formed in the beg lapped edge 102.

FIG. 15 shows the isometric drawing of the golf cart club rack assembled and attached to the golf cart golf bag strapping frame. The assembly of the frame entails connecting the two shelf 1 to the top arm of the end support bracket 57 and the top arm 48 of the centre shelf support as shown, using the joining plate 44 atop of the top shelf support 57, to join the two shelves together atop of the top shelf support 52 of the centre shelf support 51 the joining plate 76 is formed with legs 77 that are inserted into shelf two connection holes 13 and 14. The joining plate 76 secures the two shelves 2 to the top shelf support 57 through shelf holes 78. The two bottom shelves 20 are attached to the bottom shelf support 54 of the centre support bracket 51 using the joining plate 76 inserted in the legs 77 from the underside of the bottom shelf support 54 with connection holes 31 and 32. The joining plate 76 secures the two shelves 16 to the bottom shelf support 54 connection holes the assembled club rack is attached to the golf cart by connecting the and support bracket 56 vertical supports 58 to the frame lock 55 with the golf cart bag strap frame held in between.

1. The golf cart club rack is a golf club rack attached to a motorised golf cart to hold and carry the maximum permissible amount of a motorised golf clubs (14 per player therefore the club rack holds 28) for the two occupants of the golf cart during a round of golf.

2. The golf cart club rack as in claim 1 wherein the club rack comprises two shelves made from composite waterproof material one spaced above the other, formed with a rear opening through which the golf clubs are passed to enter into a harbour where the golf clubs are positioned within the station cavities formed around the harbour.

3. The golf cart club rack as in claim 1 wherein the golf clubs are positioned inverted within the top and bottom shelves with the heads of the golf clubs positioned above the top shelf and the shaft of the clubs positioned in the bottom shelf

4. The golf cart club rack as in claim 1 wherein the golf clubs positioned in each station cavity within the shelf are held in the club sleeve designed for the particular golf club to be held, these sleeves being moulded from resilient flexible material with flexible entry opening leading to a secure hold position where the club is secure on the club rack and is released through the flexible entry opening.

5. The golf cart club rack as in claim 1 wherein the surface of the top shelf is furrowed and mound to hold both right and left hand iron type clubs by the top line of the club resting in the furrow with the mound each side to prevent clashing of the head of the club causing damage to the head of the club.

6. The golf cart club rack as in claim 1 wherein there are three metal support frames for holding the two complete shelves that form the club rack, wherein the end support frame is attached to each end of the top and bottom shelf, and the centre support frame is attached to the centre of the top and bottom shelf.

7. The golf cart club rack as in claim 1 where in the club rack is fixed to the bag strapping frame of the golf cart the end support frame attached to the bag strap clasp end, and the centre support frame attached to the centre of the bag strapping frame with the top shelf held above the golf bag strapping frame and the bottom shelf held below the golf bag strapping frame.

8. The golf cart club rack as in claim 1 wherein the two putter clubs are held in flexible resilient walls shaping rest positions and flexible entries to these rest positions with the walls attached to two arms of a metal frame extending forward and connected to the top shelf with the putter club held horizontally across the golf cart with club handles presented either side of the golf cart.

9. The golf cart club rack as in claim 1 wherein the club rack is fitted with one or two accessory bags bolted to the club rack.

10. The golf cart club rack as in claim 1 wherein the club rack is fitted with a club lock comprising of two metal curved members aligned to the curve of the harbour, wherein the half circle cap fit to the top and bottom of the curved metal frames and when expanded in the harbour the half circle cap fit between the peninsula surface and the padlock holes become aligned for the padlock arm to be inserted and lock the shaft of the club in the station cavity where the club is unable to be removed from the club rack.

11. The golf cart club rack as in claim 1 wherein the club rack shelf holds golf tees, spare golf balls, golf ball cleaner and an umbrella.

12. (canceled)
